(19) United States
(12) Patent Application Publication
(10) Pub. No.: US 2008/0152886 A1
(43) Pub. Date: Jun. 26, 2008

(54) High-pressure injection moulding process for the production of optical components

(75) Inventors: Klaus Salewski, Krefeld (DE); Frank Schiemann, Odenthal (DE)

Correspondence Address: BAYER MATERIAL SCIENCE LLC, 100 BAYER ROAD, PITTSBURGH, PA, 15205, US

(73) Assignee: Bayer MaterialScience AG, Leverkusen (DE)

(21) Appl. No.: 11/977,072

(22) Filed: Oct. 23, 2007

(30) Foreign Application Priority Data
Oct. 25, 2006 (DE) 10 2006 050 382.1

(51) Int. Cl. B32B 1/00; B29D 11/00

(52) U.S. Cl. 428/220; 264/1.1

(57) ABSTRACT

The invention relates to an injection moulding process for producing thick-walled precision components, of transparent thermoplastic polymers using a mould comprising at least two mould halves, characterised in that the molten polymer is injected into the cavity of the mould and then, after the cavity of the mould has been filled, a hydraulic holding follow-up pressure of at least 1000 bar (100 MPa) is applied and the action of such a high pressure is maintained during the cooling of the melt.

The present invention relates to a plastics injection moulding process for the production of thick-walled precision components of transparent thermoplastic polymers using a mould comprising at least two mould halves, characterised in that the molten polymer is injected into the cavity of the mould and then, after filling the cavity of the mould, the polymer is subjected to a hydraulic holding follow-up pressure of at least 1,000 bar (100 MPa), and the action of such a high pressure is maintained during the cooling of the melt.

Thick-walled precision components, in particular optical precision components of thermoplastic materials, in many cases have unsatisfactory geometries from the injection moulding technology aspect. In particular the production of optically transparent moulded parts with a large wall thickness (“thick-walled”, i.e. as a rule greater than 4 mm) and the associated long cooling time of the moulded part are problematical. Furthermore the material behaviour of the plastics and the process conditions have a large influence on the shrinkage of the moulded parts and the optical properties associated therewith. The thermal volume contraction of the thermoplastic injection moulded part that occurs during the long cooling time cannot be adequately compensated in conventional injection moulding processes by the holding follow-up pressure in the case where the gating systems prematurely freeze. The geometrical defects that are thus produced by the incompletely compensated shrinkage result in defective images formed by the optical moulded parts, e.g. by plastics lenses, and thus lead inter alia to spherical aberration. A description of the injection moulding of optical parts can be found in Plastverarbeiter, June 2007, p. 32ff.

For this reason conventional injection moulding processes have not achieved great importance in the injection moulding of high-grade optical components, for example optical lenses. Complex injection compression moulding processes have recently come to occupy a dominant position for these applications.

These processes involve systems in which the formation of the target contour is achieved only after a high-precision injection by a movable hobbing punch.

Instead of the conventional shrinkage compensation by the holding follow-up pressure, in injection compression moulding the extremely precisely moved hobbing punch virtually completely compensates the thermal volume contraction. A characteristic feature of the injection compression moulding process is a very high expenditure on equipment due to the use of extremely accurately positionable injection, closing and stamping units of predominantly electrical injection moulding machines and a very complex injection moulding technology; see US 2003-0146526 A1 “Compression Moulding of Optical Lenses, EP 0968807 A1 “Injection Compression Moulding Method and Injection Compression Moulding Machine”, DE 10226301 B4 “Arrangement and process for the injection compression moulding of plastics articles as well as components produced by the process”.

The disadvantage of injection compression moulding processes for the production of optical components is the very high expenditure on apparatus and associated process technology. A further disadvantage is the unsatisfactory efficiency of the often used electrically driven injection compression moulding machines on account of the high necessary positioning accuracy with the necessary long holding follow-up pressure and hobbing times.

Patent Application DE 101 14 228 A1 discloses an injection moulding process with a regulated shrinkage behaviour in order to reduce the manufacturing dimensional tolerances. In this connection it is assumed that, after completion of the holding follow-up pressure action by sealing the gate system, the further state progression takes place isochorally down to room temperature and the cooling moulded part reaches the 1 bar line above room temperature. The shrinkage of the moulded part is then defined by the difference between the specific volume of the moulded part after isochoric cooling at the time the 1 bar line is reached, and the specific volume after the further isobaric cooling at the time room temperature is reached. Accordingly the shrinkage is an inherent property of the injection moulding process; see FIG. 2, reference numeral 21=conventional injection moulding process. It is therefore proposed in DE 101 14 228 A1 to restrict this unavoidable shrinkage due to the thermal volume contraction during the cooling process, to a reproducible dimensional deviation by regulating the mould temperature.

The object of the present invention is accordingly to provide a simplified process for avoiding the material-dependent and process-dependent shrinkage of the moulded part in the injection moulding of optical components. By using an injection mould comprising at least two mould halves the thermal volume contraction of the cooling thermoplastic injection moulded part is virtually completely compensated by a high-pressure injection moulding process, and in particular the 1 bar line is reached only at room temperature, see FIG. 2, reference numeral 22=high pressure separating plane.

The present invention accordingly provides an injection moulding process for producing thick-walled precision components, in particular optical components, such as for example lenses, mirrors, gratings or prisms, of transparent thermoplastic polymers, characterised in that the molten polymer is injected into the cavity of the mould and then, after the cavity of the mould has been filled, a hydraulic holding follow-up pressure of at least 1,000 bar (100 MPa) is applied and the pressure is maintained during the cooling of the melt.

A characteristic feature of this process is the low demand placed on the positioning accuracy of the injection and closing unit. The decisive demand on the injection moulding machine as regards quality is primarily the magnitude and a sufficient accuracy and reproducibility of the adjusted holding follow-up pressure. Conventional hydraulic injection moulding machines meet these requirements.

In a preferred process the hydraulic holding follow-up pressure is adjusted so that the internal pressure in the mould measured in the region of the greatest wall thickness of the moulded part at the time the solidification temperature of the thermoplastic polymer is reached, FIG. 2, reference numeral 16, is such that during the further isochoric cooling, FIG. 2, reference numeral 17, the moulded part on reaching room temperature, FIG. 2, reference numeral 14, would have a mould internal pressure of 1 bar (0.1 MPa) if the moulded part were not removed before room temperature is reached. The solidification temperature is understood here to mean for example the glass transition temperature of the polymer or the no flow temperature. The attainment of the 1 bar pressure value of the moulded part at room temperature can also occur as an extrapolated p-v-T function outside the injection mould after the moulded part is removed, if the removal of the moulded part takes place at elevated temperature under a residual pressure that corresponds to the course of the p-v-T function.

This course of the process can, as described, be generated by a knowledge of the p-v-T behaviour of the thermoplastic material, or alternatively also by experimental stepwise raising of the holding follow-up pressure value. The necessary holding follow-up pressure time is in this connection determined beforehand by a conventional measurement of the gate open time, or alternatively from the course of the process by determining the gate sealing index; see Kunstofftaschenbuch, 27th Edition, Saechtling, Carl Hanser Verlag, Munich, Vienna, p. 85, “Verfahren zur Bestimmung des Siegelindesx (Method for determining the gate sealing index) (according to Salewski)”.

As transparent thermoplastic polymer there is used in particular polycarbonate, polymethacrylmethylimide, cycloolefin copolymers or polyacrylate, in particular polymethyl methacrylate and particularly preferably polycarbonate.

The injection pressures necessary for the accurate production of optical components are characterised by the course of the mould internal pressure in the p-v-T diagram, and more specifically by an isochoric course of the state of the cooling moulded part, starting from when the gate sealing occurs and up to when the 1 bar line is reached at room temperature.

Until the gate sealing has occurred=reference numeral 16, FIG. 2, on account of the solidification of the gate channels commencing with the injection=reference numeral 10, FIG. 2, a very much higher hydraulic pressure is necessary=reference numeral 15, FIG. 2, than the residual pressures acting at the sealing point in the mould cavity=reference numeral 16, FIG. 2. For example, for the described isochoric process for a polycarbonate, after a cooling of the melt to a sealing temperature of 150° C. the acting residual pressure in the mould cavity must be raised, depending on the thickness and length of the casting system, by the machine hydraulics from 800 bar to a compressive pressure after the injection of the melt of at least 1600 bar, but as a rule above 2500 bar, FIG. 2, reference numeral 15. The thermal volume contraction of the gating system is overcompensated or overloaded due to the high compressive pressures. The sprues of the injection moulded parts accordingly jam in the conventional sprue bushes and/or main runners, designed as a closed channel, of injection moulds, which are filled by the machine nozzle. So that these overloaded gating systems can be removed at all from the mould, in a preferred embodiment the gate position in high-pressure precision injection moulding is arranged not perpendicular to the mould separating plane, but is located in the separating plane between the two mould halves. The gates are preferably cylindrically designed and are in this way separated in the middle into two identical halves and thereby have an optimal draft. Gate channels, for example semi-cylindrically designed gate channels, open at one side are also possible in only one of the mould halves.

The process is preferably employed in those cases in which the greatest wall thickness of the moulded part is at least 5 mm, preferably at least 6 mm.

The present invention also provides an optical plastics moulded part, in particular a lens, a mirror, a grating or a prism, obtainable by the process according to the invention.

The necessary holding follow-up pressures for the complete compensation of the shrinkage occurring during processing are for example 2700 bar for the polycarbonate type with a MVR of 60 g/10 minutes measured according to ISO 1133 at 300° C./1.2 kg (e.g. polycarbonate type Makrolon 1265® of Bayer MaterialScience AG, Germany), are 5000 bar for the more viscous and higher molecular weight polycarbonate type with a MVR of 19 g/10 minutes at 300° C./1.2 kg (e.g. polycarbonate type Makrolon 2405® from Bayer MaterialScience AG, Germany), and for a MVR of 12 g/10 minutes at 300° C./1.2 kg are 7500 bar (e.g. polycarbonate type Makrolon 26050 from Bayer MaterialScience AG, Germany), which pressures can however only be produced in commercially available injection moulding machines with an appropriate additional expenditure on machinery.

The invention is described in more detail hereinafter by way of example and with reference to the accompanying drawings, in which:

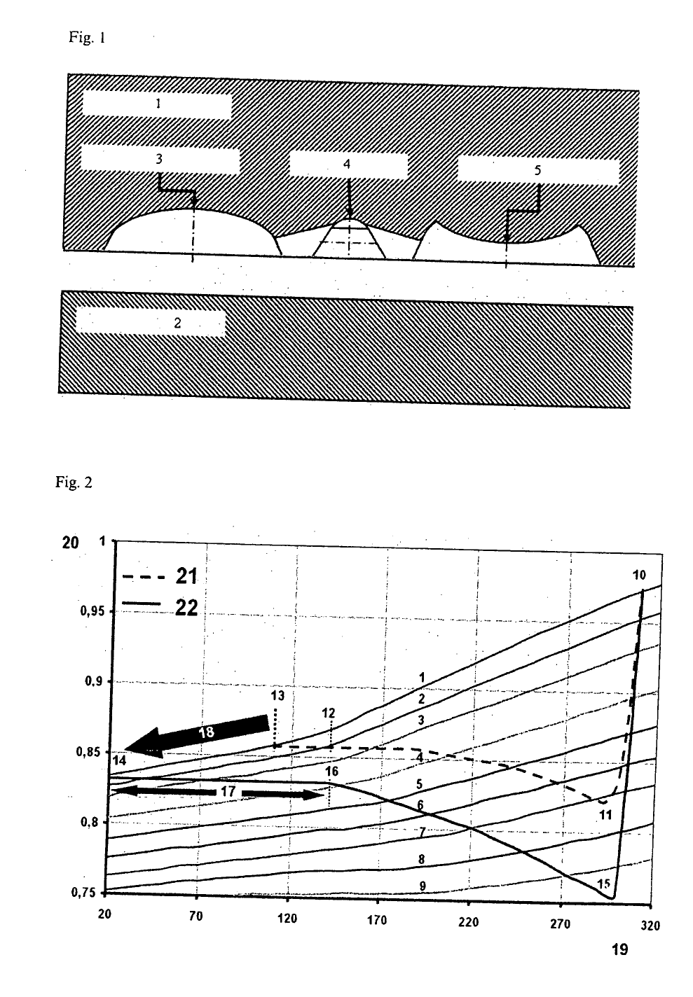

FIG. 1 is a cross-section of an injection mould with the gate and lenses in the separating plane. In this connection the reference numeral 1 denotes movable mould halves, the reference numeral 2 denotes fixed mould halves, reference numeral 3 denotes a plane-convex positive lens, reference numeral 4 denotes the casting system in the separating plane, and the reference numeral 5 denotes a plane-concave negative lens

FIG. 2 shows the p-v-T state behaviour of a conventional method compared to the high-pressure method.

In this connection the specific volume in cm³/g is plotted on the vertical axis with the reference numeral 20, and the bulk temperature in degrees Celsius is plotted on the horizontal axis with reference numeral 19. From the top downwards the lines denote the isobars at 1 bar=reference numeral 1, 200 bar=reference numeral 2, 40 bar=reference numeral 3, 800 bar=reference numeral 4, 1200 bar=reference numeral 5, 1600 bar=reference numeral 6, 2000 bar=reference numeral 7, 2400 bar=reference numeral 8 and 2800 bar=reference numeral 9 for a polycarbonate with a MVR of 60 g/10 minutes measured at 300° C./1.2 kg, for example a Makrolon 1265®.

The dotted line=reference numeral 21 denotes the course of the mould internal pressure for conventional injection moulding using conventional pressures. The shrinkage at room temperature due to the difference in specific volume between the start=reference numeral 13 and the end=reference numeral 14 of the isobaric cooling=reference numeral 18 along the 1 bar line down to room temperature can clearly be seen.

The continuous line=reference numeral 22 denotes the course of the high pressure process. In contrast to the conventional injection moulding process, the start and end of the isobaric cooling along the 1 bar line coincide at a point at room temperature=reference numeral 14, as a result of which the shrinkage is zero. A precondition for this is a prior isochoric cooling=reference numeral 17 at a sufficiently high pressure.

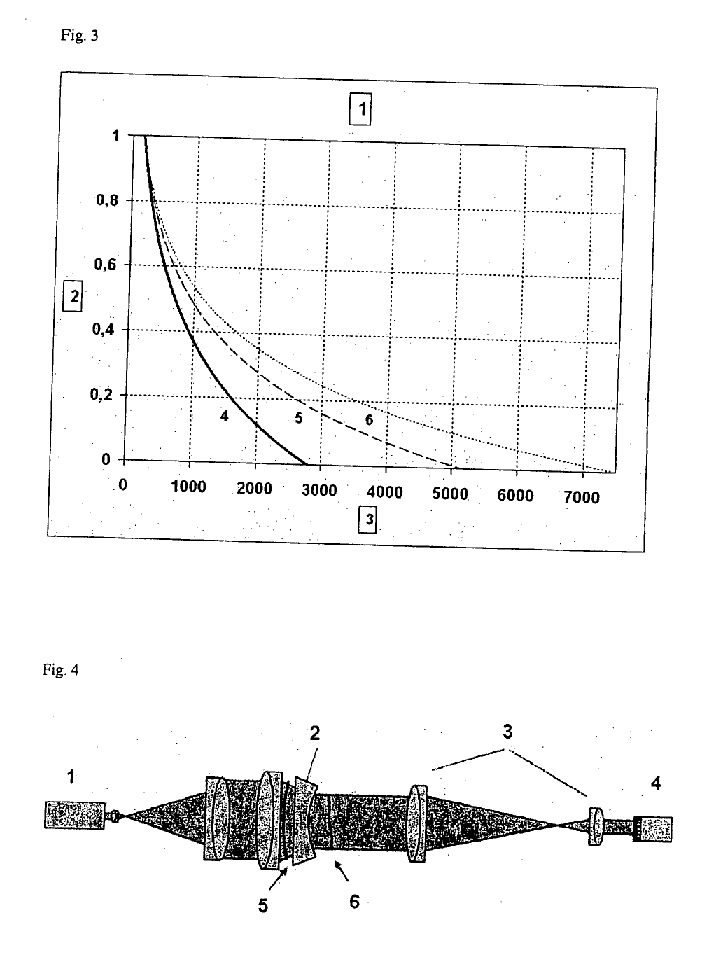

FIG. 3 illustrates the determination of the holding follow-up pressure for zero shrinkage.

The processing shrinkage in % is shown on the vertical axis with the reference numeral 2. The horizontal axis with the reference numeral 3 shows the holding follow-up pressures to be adjusted in the injection moulding machine. The shrinkage varies as a function of the holding follow-up pressure in an illustrated range from 1% to 0%. This shrinkage function depends inter alia on the viscosity of the employed plastics material.

In this example a holding follow-up pressure of 2700 bar is necessary to achieve a zero shrinkage for a low viscosity polycarbonate with a MVR of 60 g/10 minutes measured at 300° C./1.2 kg (for example Makrolon 1265®, lower continuous line identified by the reference numeral 4). The medium viscosity polycarbonate with a MVR of 19 g/10 minutes at 300° C./1.2 kg (for example polycarbonate type Makrolon 2405®, middle dotted line with the reference numeral 5) requires a significantly higher holding follow-up pressure of 5000 bar for a zero shrinkage. The higher viscosity polycarbonate with a MVR of 12 g/10 minutes at 300° C./1.2 kg (e.g. polycarbonate type Makrolon 2605®, upper fine dotted line with the reference numeral 6) on the other hand requires a holding follow-up pressure as high as 7500 bar.

FIG. 4 shows diagrammatically the experimental arrangement with the Shack-Hartmann Sensor for testing the wave front aberration.

The illumination of the lens to be tested (reference numeral 2) is carried out with a 635 nm laser (reference numeral 1) with a matched convergent wave front on the entry side (reference numeral 5). The plane wave (reference numeral 6) at the outlet of the lens to be tested carries the information on the total shape deviation of the lens surface, for example as a result of the processing shrinkage. This wave front (reference numeral 6) is formed with the aid of a Kepler telescope (reference numeral 3) on a Shack-Hartmann wave front sensor (reference numeral 4).

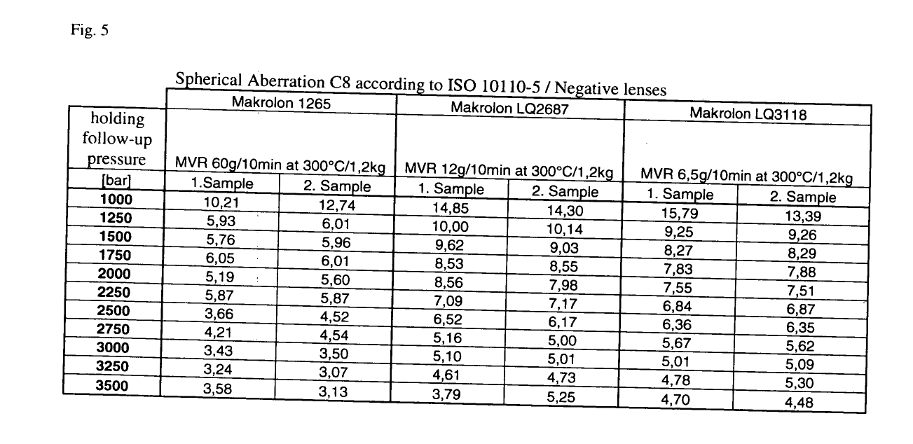

FIG. 5 shows in tabular form experimental results of the decreasing wave front aberration with increasing pressure.

In the Table the spherical aberration C8 according to ISO 10110-5 is shown in column form as a multiple of the wave length lambda (635 nm) for three types of polycarbonate, with 2 measurements in each case. The line-by-line entries show the influence of the holding follow-up pressure to be adjusted in the injection moulding machine. The spherical aberration C8 decreases with increasing holding follow-up pressure in an illustrated range from 16 lambda down to a minimum of 3 lambda. This function dependent on the holding follow-up pressure depends inter alia on the viscosity of the employed plastics material. In this example the low viscosity polycarbonate with a MVR of 60 g/10 minutes measured at 300° C./1.2 kg (e.g. Makrolon 1265®) has the smallest aberration value. The more viscous polycarbonate with a MVR of 12 g/10 minutes at 300° C./1.2 kg (e.g. polycarbonate type Makrolon LQ2687®) and the high viscosity polycarbonate nos. 5+6) with a MVR of 6.5 g/10 minutes at 300° C./1.2 kg (e.g. polycarbonate type Makrolon LQ3118®) have a more unfavourable aberration value that is higher by ca. 2 lambda.

### EXAMPLES

### Example

### Injection Moulding of Contour-Accurate Plane-Convex or Plane-Concave Lenses

The lens contours are introduced without any correction for shrinkage in a mould half designed as a multiple cavity. One of these symmetrically arranged cavities is equipped with a mould internal pressure sensor. The sensor is installed at the lens position with the greatest wall thickness. The injection of the lens cavities takes place through a cold runner with large drafts, likewise located in this mould half. This mould half contains an ejector system for removing the injection moulded part from the mould at the end of the moulding process. The injection mould is incorporated in an injection moulding machine with a large hydraulic conversion ratio in order to produce mould internal pressures of up to 3000 bar.

Transparent polycarbonate granules are plasticized at 300° C. in an injection moulding machine and injected at conventionally low pressures into the injection mould heated to 90° C. The machine parameters, namely metering stroke, change-over point, holding follow-up pressure time, etc. are optimised with this setting so that an injection moulded part with as accurate a contour as possible is formed. The holding follow-up pressure time is set so that it corresponds to the gate open time of the injection moulded part. Starting from this machine setting the injection moulding machine pressure is raised stepwise during the holding follow-up pressure phase until the mould internal pressure falling as a result of solidification reaches a pressure at the end of the gate open time (equal to the adjusted holding follow-up pressure time) which, during the further isochoric state behaviour, intersects the 1 bar line horizontally in the p-v-T diagram at room temperature (RT).

In the case of the example illustrated in FIG. 2, for the course of the high pressure process=reference numeral 22, the mould internal pressure to be aimed for at the end of the gate open time would be a residual pressure of ca. 800 bar.

As an alternative to setting the injection moulding machine via the p-v-T dependence, in the case of an unknown p-v-T behaviour the necessary holding follow-up pressure can be determined experimentally. For this purpose the holding follow-up pressure is in the same way raised stepwise when adjusting the injection moulding machine, and the processing shrinkage, or the deviation from the mould contour dimension, is determined from each injected lens. The holding follow-up pressure for zero shrinkage can be determined from the shrinkage as a function of the adjusted holding follow-up pressure; see FIG. 3.

In each case two negative lenses made of three different types of polycarbonate with different viscosities were injection moulded by the aforedescribed process and the aberration was measured with a laser at a wavelength lambda=635 nm according to the Shack-Hartmann method; see FIG. 4.

In this experiment the hydraulic holding follow-up pressure of the injection moulding machine was raised stepwise, starting at 1000 bar, up to 3500 bar. The aberration measured by the Shack-Hartmann method is reduced for the three types of polycarbonate from a range of 5 to 11 lambda at 1000 bar, to 2 to 3 lambda at 3500 bar; see FIG. 5.

1. Injection moulding process for producing thick-walled precision components of transparent thermoplastic polymers using a mould comprising at least two mould halves, characterised in that the molten polymer is injected into the cavity of the mould and then, after the cavity of the mould has been filled, a hydraulic holding follow-up pressure of at least 1000 bar (100 MPa) is applied and the action of such a high pressure is maintained during the cooling of the melt.

2. Process according to claim 1, characterised in that the pressure of the injection moulding machine in the region of the holding follow-up pressure phase is adjusted so that the mould internal pressure measured in the region of the greatest wall thickness of the moulded part at the time the solidification temperature of the thermoplastic polymer is reached, is such that, on further isochoric cooling, the moulded part on reaching room temperature would have a mould internal pressure of 1 bar (0.1 MPa) if the moulded part were not removed before room temperature is reached.

3. Process according to claim 1 or 2, characterised in that polycarbonate, polymethacrylmethylimide, cycloolefin copolymers or polyacrylate is used as transparent thermoplastic polymer.

4. Process according to one of claims 1 to 3, characterised in that a mould comprising at least two mould halves is used, in which the main runner is arranged in the separating plane of the mould halves.

5. Process according to one of claims 1 to 4, characterised in that the greatest wall thickness of the moulded part is at least 5 mm.

6. Optical moulded part obtainable by a process according to one of claims 1 to 5.
